(19) United States
(12) Patent Application Publication
(10) Pub. No.: US 2026/0055880 A1
(43) Pub. Date: Feb. 26, 2026

(54) TELESCOPIC LAMP STAND AND LAMP THEREOF

(71) Applicant: Guangdong Jusheng Lighting Co.,Ltd., Zhongshan (CN)

(72) Inventor: Shunyuan JIANG, Sichuan (CN)

(21) Appl. No.: 19/377,636

(22) Filed: Nov. 3, 2025

(30) Foreign Application Priority Data
Sep. 3, 2025 (CN) 202521903133.X

(51) Int. Cl. F21V 21/22; F21S 8/00; F21V 21/02

(52) U.S. Cl. CPC F21V 21/22; F21S 8/036; F21V 21/02

(57) ABSTRACT

A telescopic lamp stand includes a fixed tube, a first sliding groove provided at left and right ends of the fixed tube, first moving tubes provided in the left end and right end of the first sliding groove and are movable left and right along the first sliding groove, and a first limiting assembly provided on the fixed tube and configured to restrict the first moving tubes from disengaging from the first sliding groove and to position the first moving tubes. This allows for adjustment of the length of the lamp stand according to actual usage requirements, thereby improving its applicability. A lamp is further provided, including the aforementioned lamp stand, where a lamp head for illumination is connected to a bottom of the lamp stand, and a base configured to be fixed to a wall is connected to a rear side of the lamp stand.

### CROSS REFERENCE TO RELATED APPLICATIONS

The present disclosure claims the priority of Chinese Patent Application No. 202521903133.X filed on Sep. 3, 2025 before CNIPA. All the above are hereby incorporated by reference in their entirety.

### TECHNICAL FIELD

The present disclosure relates to the technical field of lamps, and particularly to a telescopic lamp stand and a lamp thereof.

### BACKGROUND

In modern life and work scenarios, lighting equipment has become an indispensable infrastructure, and the lamp stand, as a core supporting component of the lamp, directly affects the flexibility of use, applicable scenarios, and space utilization efficiency of the lamp through its structural design.

Conventional lamp stands typically adopt an integrated fixed structure, and a length thereof is unable to be adjusted after manufacturing. This results in numerous issues in practical applications: when illuminating large spaces (such as living rooms or exhibition halls), fixed short-length lamp stands may not meet the requirements for broad illumination coverage, necessitating additional lamps. This not only increases usage costs but may also lead to messy wiring, affecting spatial aesthetics. Conversely, when used in small spaces (such as bedrooms or bathrooms), excessively long fixed lamp stands occupy too much space, easily interfering with other furniture or equipment and reducing space utilization efficiency. Furthermore, fixed-size lamp stands are inconvenient to package and store, thereby increasing transportation and storage difficulties.

### SUMMARY

In view of the above, an objective of the present disclosure is to provide a telescopic lamp stand and a lamp thereof with high applicability and convenient transportation and storage.

The present disclosure provides a telescopic lamp stand, including a fixed tube, where a first sliding groove is provided in the fixed tube and along a length direction of the fixed tube; two first moving tubes are provided in the first sliding groove and are movable along the first sliding groove, wherein one first moving tube is provided at an left end of the fixed tube and another first moving tube is provided at an right end of the fixed tube; two first limiting assemblies are provided on the fixed tube and are configured to restrict the first moving tube from disengaging from the first sliding groove, wherein one first limiting assembly is provided on the left end of the fixed tube and is configured to restrict the first moving tube provided at the left end of the fixed tube from disengaging from the first sliding groove, and another first limiting assembly is provided on the right end of the fixed tube and is configured to restrict the first moving tube provided at the right end of the fixed tube from disengaging from the first sliding groove.

In some implementations of the present disclosure, a gap is formed between an outer wall of each of the first moving tubes and an inner wall of the first sliding groove, a first collar is arranged at an end of each of the first moving tubes inserted into the first sliding groove and is configured to abut against the inner wall of the first sliding groove, and the first collar is configured to abut against the first limiting assembly to prevent each of the first moving tubes from falling off.

In some implementations of the present disclosure, each of the two first limiting assemblies includes a second collar sleeved on each of the left end and right end of the fixed tube, and a first plastic ring embedded in the second collar, where an inner diameter of the first plastic ring is smaller than an inner diameter of the first moving tube.

In some implementations of the present disclosure, the first collar is made of metal or plastic, and the second collar is made of metal or plastic.

In some implementations of the present disclosure, a second sliding groove is provided at an extending end of each of the first moving tubes and along a length direction of each of the first moving tubes, a second moving tube is arranged in the second sliding groove and is movable along the second sliding groove, and a second limiting assembly is arranged on each of the first moving tubes and is configured to restrict the second moving tubes from disengaging from the second sliding groove.

In some implementations of the present disclosure, a gap is formed between an outer wall of the second moving tubes and an inner wall of the second sliding groove, a third collar is arranged at an end of each of the second moving tubes inserted into the second sliding groove and is configured to abut against the inner wall of the second sliding groove, and the third collar is configured to abut against the second limiting assembly to prevent the second moving tube from falling off.

In some implementations of the present disclosure, the second limiting assembly includes a fourth collar sleeved on the extending end of each of the first moving tubes, and a second plastic ring embedded in the fourth collar, where an inner diameter of the second plastic ring is smaller than an inner diameter of the second moving tube.

In some implementations of the present disclosure, the third collar is made of metal or plastic, and the fourth collar is made of metal or plastic.

In some implementations of the present disclosure, each of the fixed tube, the first moving tube, and the second moving tube has a cross-section shape selected from one of circular, square, rhombic, and elliptical.

The present disclosure further provides a lamp, including the aforementioned lamp stand, where a first connector is provided at a bottom of each of the fixed tube, the first moving tube, and the second moving tube; a lamp head for illumination is connected to the first connector, a second connector is provided at a rear side of the fixed tube, one end of a connecting rod is connected to the second connector, and a base configured to be fixed to a wall is connected to an opposite end of the connecting rod.

The beneficial effects of the present disclosure are as follows: the telescopic lamp stand includes a fixed tube, where first sliding groove is provided at left and right ends of the fixed tube, first moving tubes are provided in the first sliding groove at the left and right ends and are movable left and right along the first sliding groove, and a first limiting assembly is provided on the fixed tube and is configured to restrict the first moving tubes from disengaging from the first sliding groove and to position the first moving tubes. This allows for adjustment of the length of the lamp stand according to actual usage requirements, thereby improving its applicability. During transportation, the lamp stand may be retracted to its shortest length, thereby avoiding increased shipping costs due to oversized packaging, facilitating transportation, and also making storage more convenient.

### BRIEF DESCRIPTION OF THE DRAWINGS

FIG. 1 is a schematic view of a first embodiment of the telescopic lamp stand of the present disclosure;

FIG. 2 is a cross-sectional view of the first embodiment of the telescopic lamp stand of the present disclosure;

FIG. 3 is an enlarged view of portion A of FIG. 2 of the present disclosure;

FIG. 4 is a partial schematic view of a second embodiment of the telescopic lamp stand of the present disclosure;

FIG. 5 is a partial cross-sectional view of the second embodiment of the telescopic lamp stand of the present disclosure;

FIG. 6 is an enlarged view of portion B of FIG. 2 of the present disclosure;

FIG. 7 is a schematic view of a third embodiment of the telescopic lamp stand of the present disclosure;

FIG. 8 is a schematic view of the lamp when the telescopic lamp stand corresponds to the first embodiment;

FIG. 9 is a schematic view of the lamp when the telescopic lamp stand corresponds to the second embodiment;

FIG. 10 is a schematic view of the lamp when the telescopic lamp stand corresponds to the third embodiment.

### DETAILED DESCRIPTION

The embodiments of the present disclosure are clearly and completely described below in conjunction with the attached drawings.

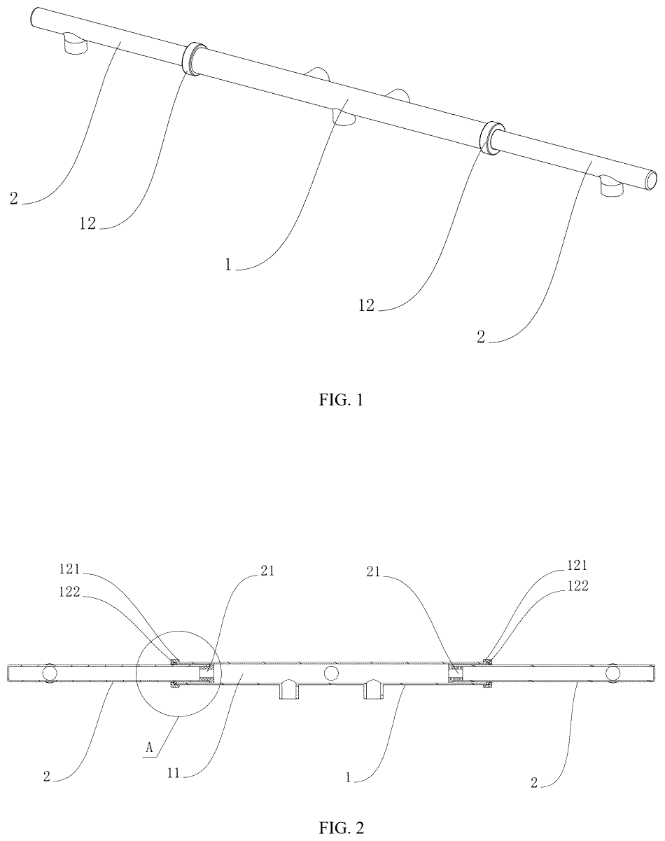

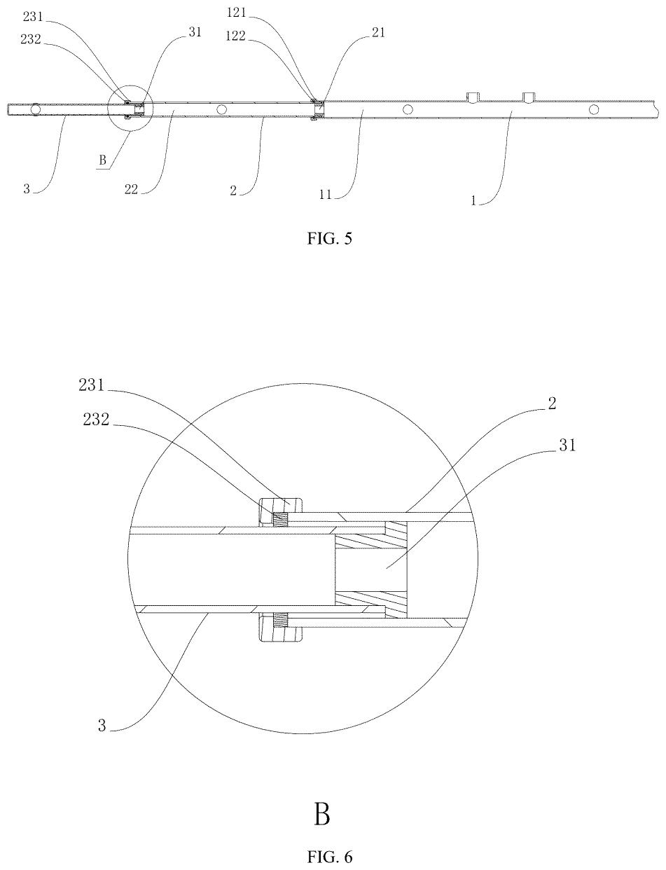

With reference to FIGS. 1 to 7, in a first embodiment of the present disclosure, a telescopic lamp stand includes a fixed tube 1, where first sliding groove 11 is provided at left and right ends of the fixed tube 1 and along a length direction of the fixed tube 1, first moving tubes 2 are provided in the first sliding groove 11 at the left and right ends and are movable left and right along the first sliding groove 11, and a first limiting assembly 12 is provided on the fixed tube 1 and is configured to restrict the first moving tubes 2 from disengaging from the first sliding groove 11. The first limiting assembly 12 may also be configured to position the first moving tubes 2, so that the first moving tubes 2 may be moved to appropriate positions for use. This allows for adjustment of the length of the lamp stand according to actual usage requirements, thereby improving its applicability. During transportation, the lamp stand may be retracted to its shortest length, thereby avoiding increased shipping costs due to oversized packaging, facilitating transportation, and also making storage more convenient.

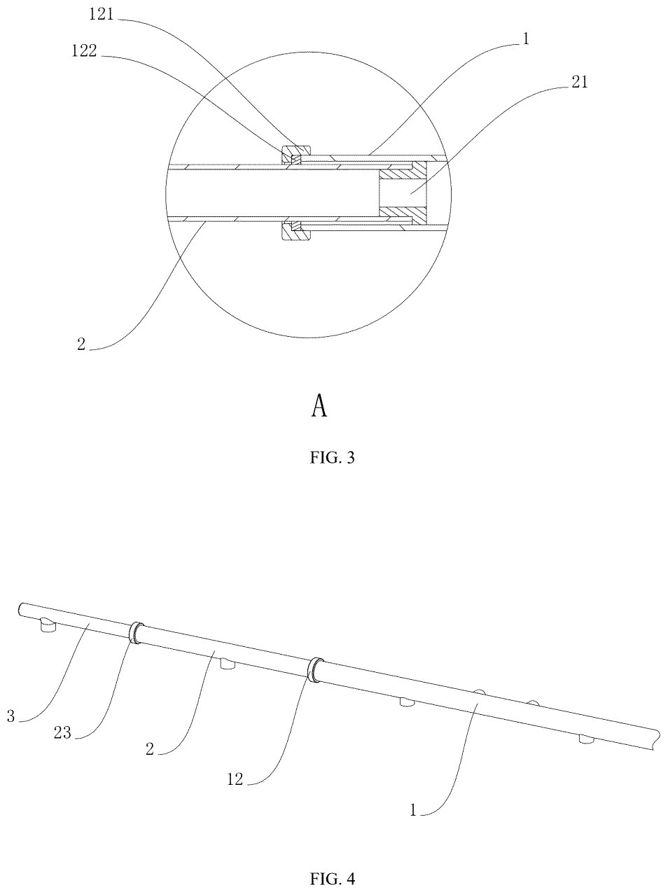

With reference to FIGS. 2 and 3, a gap is formed between an outer wall of each first moving tube 2 and an inner wall of the first sliding groove 11, thereby facilitating movement of the first moving tubes 2 within the first sliding groove 11. A width of the gap is preferably 0.3-3 mm, which is adaptively adjusted according to a diameter of each of the first moving tubes 2, so as to prevent shaking of the first moving tubes 2 in the sliding grooves due to an excessively large gap. A first collar 21 is provided at an end of each first moving tube 2 inserted into the corresponding first sliding groove 11 and is configured to abut against the inner wall of the corresponding first sliding groove 11. The first collar 21 is configured to abut against the first limiting assembly 12 to prevent the first moving tubes 2 from falling off. The first collar 21 has a T-shape and is fixed to the first moving tubes 2 by means of adhesion or screw fastening.

Furthermore, the first limiting assembly 12 includes a second collar 121 sleeved on each of the left and right ends of the fixed tube 1, and a first plastic ring 122 embedded in each second collar 121. The second collar 121 may be fixed to the first moving tubes 2 by means of adhesion or screw fastening. An inner diameter of each first plastic ring 122 is smaller than an inner diameter of each first moving tube 2, with a difference of 0.05-1 mm, which is adaptively adjusted according to the diameter of the first moving tubes 2. This allows slight elastic deformation generated by the plastic rings to provide a certain damping force to the first moving tubes 2, preventing them from sliding autonomously without manual operation while not affecting normal telescopic adjustment. Additionally, stepless adjustment of the extension length of the first moving tubes 2 may be achieved. Meanwhile, by abutting the first plastic rings 122 against the first collars 21, disengagement of the first moving tubes 2 from the first sliding groove 11 may be prevented. Furthermore, edges of inner holes of the first plastic rings 122 are rounded, and their material is relatively soft, thereby avoiding scratching of the outer walls of the first moving tubes 2 and preventing damage to the overall appearance of the lamp stand.

In some implementations, the first collar 21 and the second collar 121 are made of metal or plastic.

With reference to FIGS. 4 to 6, in a second embodiment of the present disclosure, a second sliding groove 22 is provided at an extending end of each first moving tube 2 and along a length direction of the first moving tube 2. A second moving tube 3 is provided in each second sliding groove 22 and is movable left and right along the second sliding groove 22. A second limiting assembly 23 is provided on each first moving tube 2 and is configured to restrict the second moving tubes 3 from disengaging from the second sliding grooves 22. This enables two-stage telescopic adjustment of the lamp stand, further expanding the length adjustment range of the lamp stand to meet illumination layout requirements for larger spaces (such as large exhibition halls or conference rooms). Meanwhile, the design logic of the two-stage telescopic structure remains consistent with that of the first-stage telescopic structure, ensuring coordination and stability of the overall structure. Certainly, the lamp stand may also include corresponding three-stage or higher-stage telescopic structures.

Specifically, a gap is formed between an outer wall of each second moving tube 3 and an inner wall of each second sliding groove 22. A third collar 31 is provided at an end of each second moving tube 3 inserted into the corresponding second sliding groove 22 and is configured to abut against the inner wall of the corresponding second sliding groove 22. The third collar 31 is configured to abut against the second limiting assembly 23 to prevent the second moving tubes 3 from falling off. The second limiting assembly 23 includes a fourth collar 231 sleeved on the extending end of each first moving tube 2, and a second plastic ring 232 embedded in each fourth collar 231. An inner diameter of each second plastic ring 232 is smaller than an inner diameter of each second moving tube 3. The third collar 31 and the fourth collar 231 are made of metal or plastic.

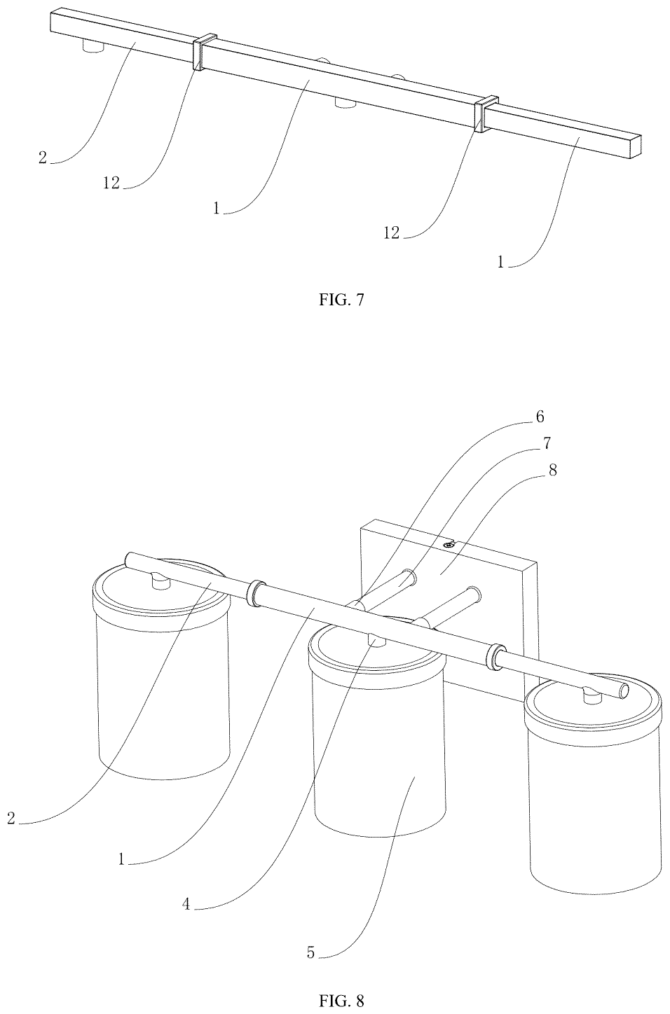

In the above embodiments, each of the fixed tube 1, the first moving tubes 2, and the second moving tubes 3 has a cross-section shape selected from the group consisting of circular, square, rhombic, and elliptical. As shown in FIG. 7, in a third embodiment of the disclosure, the fixed tube 1, the first moving tubes 2, and the second moving tubes 3 have a square shape, thereby improving product adaptability and enhancing market competitiveness.

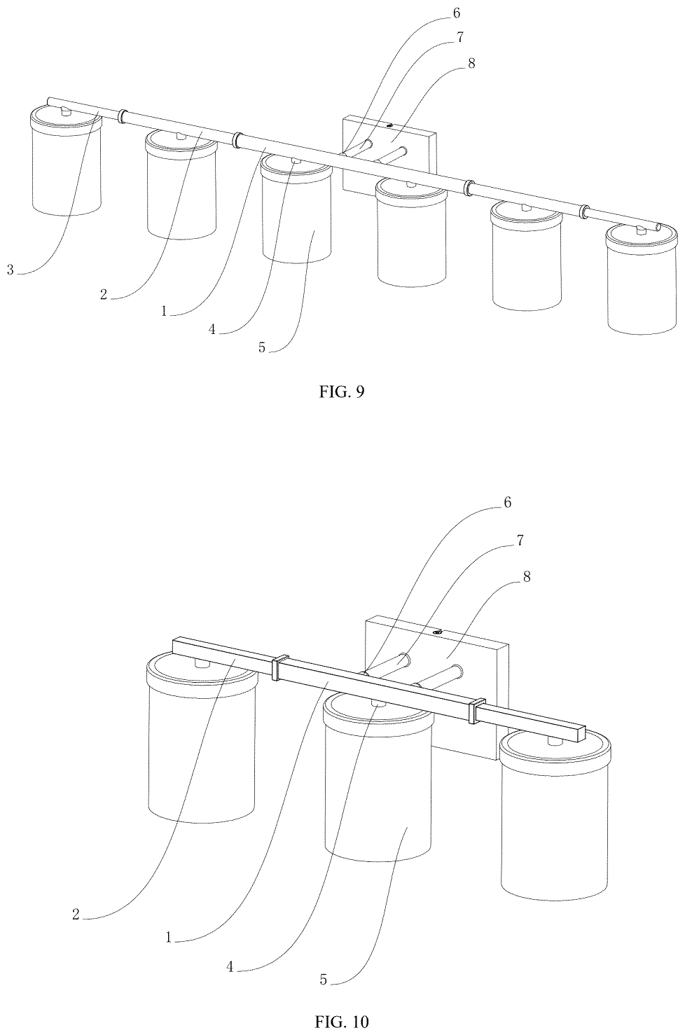

With reference to FIGS. 8 to 10, the present disclosure further provides a lamp, adopting the aforementioned lamp stand, where a first connector 4 is provided at a bottom of each of the fixed tube 1, the first moving tubes 2, and the second moving tubes 3. A lamp head 5 for illumination is detachably connected to each first connector 4 through a threaded connection. A second connector 6 is provided at a rear side of the fixed tube 1. One end of a connecting rod 7 is detachably connected to the second connector 6 through a threaded connection. A base 8 configured to be fixed to a wall is detachably connected to an opposite end of the connecting rod 7 through a threaded connection. Thus, during transportation of the lamp, the lamp stand, the lamp head 5, and the base 8 may be disassembled for packaging and transportation, thereby avoiding increased shipping costs due to oversized packaging.

The above descriptions of the ideal embodiments of the present disclosure are provided for illustrative purposes. Based on the above description, relevant personnel may make various changes and modifications without departing from the scope of the technical idea of the present disclosure. The technical scope of the present disclosure is not limited to the content of the description but should be determined by the scope of the claims.

What is claimed is:

1. A telescopic lamp stand, comprising a fixed tube, wherein a first sliding groove is provided in the fixed tube and along a length direction of the fixed tube; two first moving tubes are provided in the first sliding groove and are movable along the first sliding groove, wherein one first moving tube is provided at an left end of the fixed tube and another first moving tube is provided at an right end of the fixed tube; two first limiting assemblies are provided on the fixed tube and are configured to restrict the first moving tube from disengaging from the first sliding groove, wherein one first limiting assembly is provided on the left end of the fixed tube and is configured to restrict the first moving tube provided at the left end of the fixed tube from disengaging from the first sliding groove, and another first limiting assembly is provided on the right end of the fixed tube and is configured to restrict the first moving tube provided at the right end of the fixed tube from disengaging from the first sliding groove.

2. The telescopic lamp stand according to claim 1, wherein a gap is formed between an outer wall of each of the first moving tubes and an inner wall of the first sliding groove, a first collar is arranged at an end of each of the first moving tubes inserted into the first sliding groove and is configured to abut against the inner wall of the first sliding groove, and the first collar is configured to abut against the first limiting assembly to prevent each of the first moving tubes from falling off.

3. The telescopic lamp stand according to claim 2, wherein each of the two first limiting assemblies comprises a second collar sleeved on each of the left end and right end of the fixed tube, and a first plastic ring embedded in the second collar, wherein an inner diameter of the first plastic ring is smaller than an inner diameter of the first moving tube.

4. The telescopic lamp stand according to claim 3, wherein the first collar is made of metal or plastic, and the second collar is made of metal or plastic.

5. The telescopic lamp stand according to claim 1, wherein a second sliding groove is provided at an extending end of each of the first moving tubes and along a length direction of each of the first moving tubes, a second moving tube is arranged in the second sliding groove and is movable along the second sliding groove, and a second limiting assembly is arranged on each of the first moving tubes and is configured to restrict the second moving tube from disengaging from the second sliding groove.

6. The telescopic lamp stand according to claim 5, wherein a gap is formed between an outer wall of the second moving tube and an inner wall of the second sliding groove, a third collar is arranged at an end of the second moving tube inserted into the second sliding groove and is configured to abut against the inner wall of the second sliding groove, and the third collar is configured to abut against the second limiting assembly to prevent the second moving tube from falling off.

7. The telescopic lamp stand according to claim 6, wherein the second limiting assembly comprises a fourth collar sleeved on the extending end of each of the first moving tubes, and a second plastic ring embedded in the fourth collar, wherein an inner diameter of the second plastic ring is smaller than an inner diameter of the second moving tube.

8. The telescopic lamp stand according to claim 7, wherein the third collar is made of metal or plastic, and the fourth collar is made of metal or plastic.

9. The telescopic lamp stand according to claim 5, wherein each of the fixed tube, the first moving tube, and the second moving tube has a cross-section shape selected from one of circular, square, rhombic, and elliptical.

10. A lamp, comprising a lamp stand according to claim 5, wherein a first connector is provided at a bottom of each of the fixed tube, the first moving tube, and the second moving tube; a lamp head for illumination is connected to the first connector, a second connector is provided at a rear side of the fixed tube, one end of a connecting rod is connected to the second connector, and a base configured to be fixed to a wall is connected to an opposite end of the connecting rod.
